(19) United States
(12) Patent Application Publication
(10) Pub. No.: US 2026/0110581 A1
(43) Pub. Date: Apr. 23, 2026

(54) JUNCTION TEMPERATURE MONOLITHIC OPTO-THERMOMETER

(71) Applicant: FORD GLOBAL TECHNOLOGIES, LLC, Dearborn, MI (US)

(72) Inventors: John P. Casci, Pontiac, MI (US); Baoming Ge, Okemos, MI (US); Fan Wang, Novi, MI (US)

(21) Appl. No.: 18/920,098

(22) Filed: Oct. 18, 2024

(51) Int. Cl. G01K 11/125

(52) U.S. Cl. CPC G01K 11/125

(57) ABSTRACT

This disclosure relates to a silicon based power device with an integrated optomechanical temperature sensing system. The device, in some examples, comprises a silicon die with a photonic crystal cavity, a photodiode, and a photodetector monolithically embedded within. Positioned at ends of the photonic crystal cavity, the photodiode emits photons, while the photodetector detects photon intensity. A silicon based mechanical component located within the cavity deforms in response to temperature changes, modulating the reflection of the photons. This deformation allows for the measurement of junction temperature by analyzing the intensity of the reflected photons.

### TECHNICAL FIELD

This disclose relates to power semiconductor devices.

### BACKGROUND

Silicon Carbide (SiC) power devices are constructed using silicon carbide, a compound semiconductor material composed of silicon and carbon atoms arranged in a crystalline structure. SiC belongs to a class of materials known as wide-bandgap semiconductors, which have an energy bandgap significantly larger than that of traditional silicon. This wider bandgap is a feature that enables SiC devices to perform well in high-voltage, high-temperature, and high-frequency applications.

### SUMMARY

A silicon based power device comprises a silicon die, within which a photonic crystal cavity, a photodiode, and a photodetector are monolithically embedded. The photodiode and photodetector are positioned at ends of the photonic crystal cavity. Additionally, a silicon based mechanical component is located within the photonic crystal cavity. This mechanical component is designed to deform in response to temperature changes within the silicon die, thereby modulating the behavior of the light transmitted through the cavity.

A method for measuring the junction temperature of a silicon based power device involves applying a voltage to a photodiode embedded within the silicon die. This action causes the photodiode to emit photons into a photonic crystal cavity, also embedded in the silicon die, which contains a silicon based mechanical component. The photons travel through the cavity and are reflected by the mechanical component, which deforms in response to temperature fluctuations. The method generates an output signal by detecting the intensity of the photons reflected from the mechanical component, with the intensity corresponding to the junction temperature.

A monolithic junction thermometer comprises an integrated circuit embedded in a silicon based die, which includes both a photodiode and a photodetector. These components are operably connected via a photonic crystal cavity within the die. The cavity contains a silicon based mechanical component designed to deform in response to temperature changes in the silicon die, enabling the detection and measurement of junction temperature via changes in photon intensity reflected within the cavity.

### BRIEF DESCRIPTION OF THE DRAWINGS

FIG. 1A is a plan view of a SiC power device.

FIG. 1B is a side view, in cross section, of the SiC power device of FIG. 1B.

FIG. 2 is a schematic diagram of portions of the SiC power device of FIG. 1A.

FIG. 3 is a plan view of another SiC power device.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A component of a SiC power device is the semiconductor junction, which is typically formed through a process known as doping. Doping involves introducing impurities into the SiC crystal lattice to create regions with differing electrical properties. For SiC devices, n-type regions are created by doping SiC with donor atoms, while p-type regions are formed by doping with acceptor atoms. Together, these doped regions form a p-n junction, which is responsible for the core switching behavior of the device. SiC power devices are commonly fabricated as diodes (rectifiers) or transistors, with Metal-Oxide-Semiconductor Field-Effect Transistors (MOSFETs) being widely used in power conversion systems, like those used in vehicles, due to their efficient switching capabilities.

The basic operation of SiC devices, like other semiconductor devices, revolves around controlling the flow of electrons across the p-n junction. For instance, in SiC MOSFETs, when a voltage is applied to the gate terminal, it creates an electric field in the semiconductor, modulating the conductivity of the SiC channel between the source and drain terminals. This process allows or blocks current flow through the device. The wide bandgap of SiC allows these devices to sustain much higher electric fields without breakdown, enabling them to operate at significantly higher voltages and temperatures compared to silicon based MOSFETs.

SiC power devices are known for their ability to operate under extreme conditions. This resilience is due to the strong covalent bonds between the silicon and carbon atoms in the crystal lattice, which impart excellent thermal conductivity. As a result, SiC devices can function at junction temperatures much higher than their silicon counterparts. However, this same robust lattice structure makes it more difficult to integrate features like on-die temperature sensors, posing challenges for real-time thermal management, especially under dynamic operational conditions.

The fabrication of SiC devices requires specialized manufacturing techniques. SiC wafers are typically produced by growing high-purity single-crystal SiC boules using methods such as Physical Vapor Transport (PVT) or Chemical Vapor Deposition (CVD). Once the boules are grown, they are sliced into thin wafers, which undergo various processing steps, including ion implantation, etching, and metallization, to form the required device structures such as p-n junctions, contacts, and gates.

In addition to diodes and MOSFETs, SiC power devices can also be fabricated in other configurations, including Junction Field-Effect Transistors (JFETs) and Bipolar Junction Transistors (BJTs). Each device type offers unique advantages suited to specific applications. For example, SiC Schottky Barrier Diodes (SBDs) are preferred for high-efficiency rectification due to their low forward voltage drop and fast switching speeds. On the other hand, SiC MOSFETs are favored in high voltage switching applications, where minimal switching losses and high voltage handling are desired.

Despite the advantages of SiC devices, most SiC chips currently available do not include integrated on-die temperature sensors capable of directly measuring junction temperature. This limitation necessitates the use of indirect methods for temperature monitoring. Typically, junction temperature is estimated using external sensors or inferred through algorithmic models based on device operation, but these methods may lack precision, especially during rapid temperature fluctuations.

The absence of precise temperature measurement mechanisms may affect the performance and efficiency of SiC power devices. Inaccurate temperature readings can lead to suboptimal power derating, where the power output is unnecessarily reduced. This inefficiency can also affect chip size optimization during the design process, as designers might oversize chips to account for uncertain thermal behavior. Moreover, inaccurate temperature measurements can result in device wear.

This disclosure proposes systems that allow for direct measurement of the junction temperature in a SiC device without the need to oversize the chip. By incorporating on-die temperature sensing technology, these arrangements provide real-time, accurate temperature monitoring, which may enable better power control and enhanced device reliability.

A component of the temperature sensing system is a photonic crystal cavity, which transmits photons. The optical cavity can be monolithically fabricated from silicon during the same lithography process used to form the SiC die. As a nanostructure, the optical cavity can be placed at various locations on the SiC die or distributed across multiple locations to enable comprehensive temperature sensing. Its mechanical design provides inherent resistance to external vibrations, allowing stable operation even in high-stress environments. The optical cavity operates based on photonic resonance and intensity modulation, as opposed to the current and voltage fluctuations used in traditional resistance thermometers. This makes the system more immune to electromagnetic interference, even in environments with high electrical noise.

The system includes photodetectors, also fabricated from silicon, which are sensitive to photons and utilize photonic thermometry to analyze the spectral characteristics of the SiC chip. Specifically, the photodetectors measure the intensity of photons emitted by photodiodes, which are reflected off mechanical elements and transmitted through the optical cavity. This process provides direct information regarding the junction temperature of the SiC die. The photodetectors then convert the photon intensity into electrical signals that are transmitted to a central control board for real-time system monitoring and management.

The mechanical elements are responsible for modulating the reflected photon intensity based on thermal expansion and contraction. These elements are designed from materials such as silicon or silicon nitride, which exhibit predictable mechanical deformation under varying temperatures. Positioned within the optical cavity, the mechanical elements deform in response to temperature fluctuations in the SiC die, altering the reflection angle and intensity of the photons.

This system can be extended to measure temperature at multiple locations on the SiC die. Incorporating temperature sensors at several points across the die allows for high-resolution thermal mapping, providing data for optimizing thermal management. Additionally, multi-point temperature sensing can identify patterns that may enable predictive maintenance.

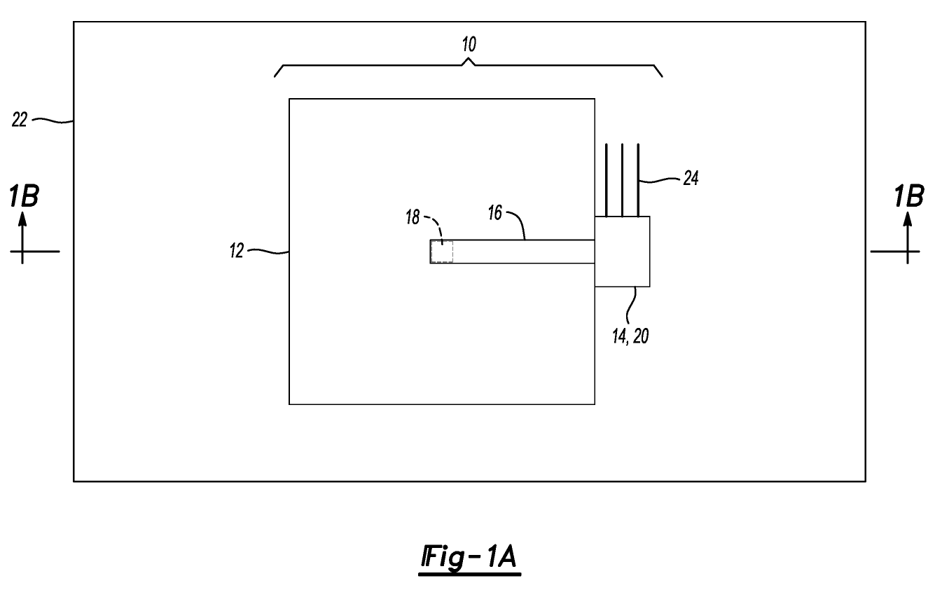

As illustrated in FIG. 1A, an optomechanical temperature sensor system 10 is integrated within a SiC die 12 and includes photodiodes 14, optical cavities 16, mechanical elements 18, photodetectors 20, and Direct Bonded Copper (DBC) layer 22. These components are monolithically embedded in the SiC die 12, facilitating real-time temperature monitoring and addressing the challenges associated with traditional, indirect temperature measurement methods.

The photodiodes 14, located near certain areas of the SiC die 12, emit photons that are transmitted through the optical cavities 16. These optical cavities 16, fabricated from silicon, act as waveguides for the photons. The photons are directed toward the mechanical elements 18, which modulate the photon intensity based on the temperature-induced deformation.

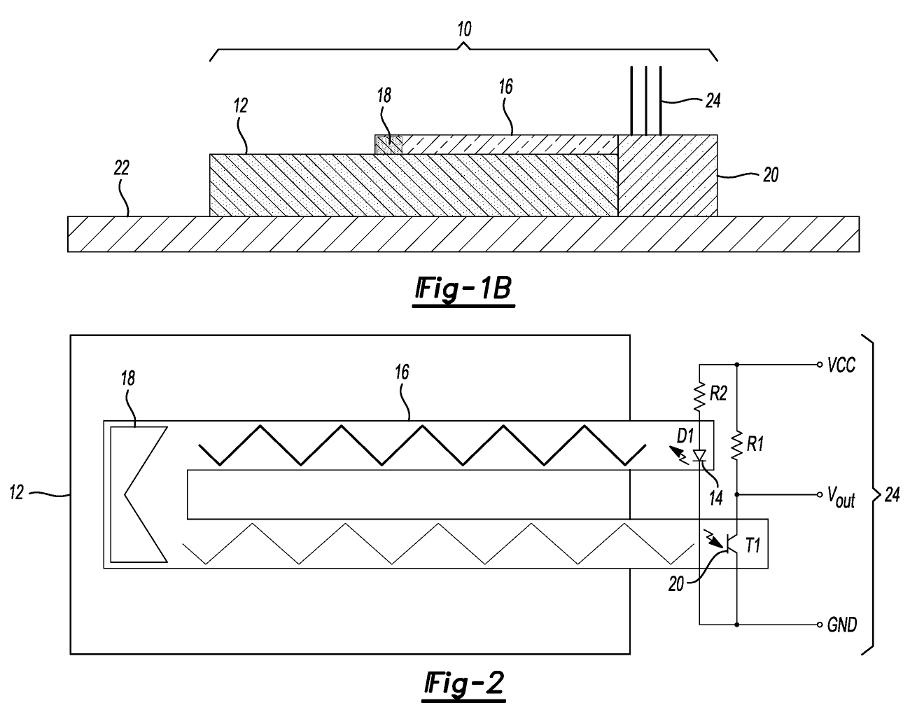

As shown in FIG. 1B, the mechanical elements 18 are placed within the optical cavities 16 and are designed to deform in response to temperature changes in the SiC die 12. This deformation alters the reflective properties of the cavities 16, modulating the intensity and angle of the reflected photons. The photodetectors 20, located at an endpoint of one of the optical cavities 16 as shown in FIG. 2, detect the modulated photons and convert the variations in photon intensity into electrical signals. These signals, which are transmitted as signal outputs 24 to an external control system, provide real-time data on the junction temperature.

The circuitry responsible for this detection and conversion includes resistors R1 and R2, the photodiode 14, and the photodetector 20, which are arranged to enable light emission, detection, and signal processing.

A focus of the circuit is the interaction between the photodiode 14 and the photodetector 20. The photodiode 14 emits light when powered by the supply voltage VCC. This emitted light travels through the optical cavity 16, reflected off the mechanical element 18, and then travels back through the optical cavity 16 to be captured by the photodetector 20. The role of the photodetector 20 is to detect the reflected light and convert the light intensity into an electrical signal.

R1 and R2 are positioned in the circuit to control current and voltage levels, providing proper biasing and operating conditions for both the photodiode 14 and photodetector 20. R2 is typically placed in series with the photodiode 14 to control the current flow through it. R1 is often connected to the photodetector 20 to control the voltage and sensitivity of the detection process, ensuring that the photodetector operates within its optimal range.

The supply voltage VCC provides power to the circuit, delivering the necessary voltage for both light emission by the photodiode 14 and light detection by the photodetector 20. The ground GND serves as the reference point for the circuit, providing a return path for the current.

The output voltage Vout is generated based on the intensity of the light detected by the photodetector 20. As more light is reflected and detected by the photodetector 20, the output voltage Vout will change accordingly, providing the signal 24 that corresponds to the amount of reflected light. This signal 24 can then be processed for further analysis.

The DBC layer 22, positioned beneath the SiC die 12, serves to provide both electrical conduction, insulation, and efficient heat dissipation. The DBC layer 22 may include a ceramic core sandwiched between two layers of copper, providing mechanical stability and a platform for routing electrical connections of SiC dies, and a mechanical platform for the photodiodes 14, photodetectors 20, and other components of the system 10.

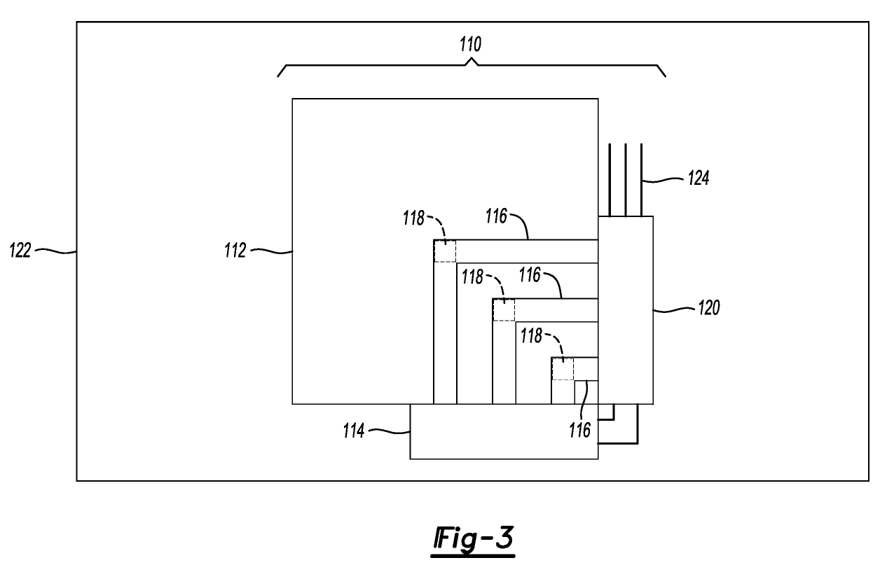

As depicted in FIG. 3, the system 110 can be scaled to support multi-point temperature sensing across the SiC die 112. This extended configuration involves multiple sets of photodiodes 114, optical cavities 116, mechanical elements 118, and photodetectors 120, which are distributed across the die 112. This arrangement allows for the detection of temperature gradients across the SiC chip, facilitating precision of over-temperature control mechanisms and enabling thermal mapping of the device.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. Any reference to a singular element includes the possibility of plural elements, and any reference to plural elements includes the possibility of singular elements.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A silicon power device comprising:
a silicon based die;
a photonic crystal cavity, photodiode, and photodetector monolithically embedded in the silicon based die such that the photodiode and photodetector are at ends of the photonic crystal cavity; and
a silicon based mechanical element in the photonic crystal cavity configured to deform responsive to temperature changes associated with the silicon based die.

2. The silicon power device of claim 1 further comprising circuitry arranged with the photodiode and photodetector and configured to generate an output signal indicative of a temperature of the silicon based die.

3. The silicon power device of claim 2, wherein the output signal is a voltage signal.

4. The silicon power device of claim 1, wherein the photonic crystal cavity is configured to transmit photons emitted by the photodiode, and reflected by the silicon based mechanical element, to the photodetector.

5. The silicon power device of claim 1, wherein the silicon based mechanical element includes silicon nitride.

6. The silicon power device of claim 1, wherein the silicon based die is a silicon carbide die.

7. A method of measuring junction temperature of a silicon based power device comprising:
applying a voltage to a photodiode, monolithically embedded in a silicon based die, such that the photodiode emits photons into a photonic crystal cavity, monolithically embedded in the silicon based die and having a silicon based mechanical element therein, and the photons reflect off the silicon based mechanical element; and
generating an output signal based on an intensity of the photons reflected by the silicon based mechanical element.

8. The method of claim 7, wherein the applying is further such that the photons reflected by the silicon based mechanical element are detected by a photodetector configured to measure the intensity.

9. A monolithic junction thermometer comprising:
circuitry including a photodiode and photodetector; and
a photonic crystal cavity integrated with a silicon based die, operably arranged with the photodiode and photodetector, and including a silicon based mechanical element configured to deform responsive to temperature changes associated with the silicon based die.

10. The monolithic junction thermometer of claim 9, wherein the photodiode and photodetector are integrated with the silicon based die.

11. The monolithic junction thermometer of claim 10, wherein the photodiode is configured to emit photons responsive to voltage applied thereto.

12. The monolithic junction thermometer of claim 11, wherein the photonic crystal cavity is configured to transmit the photons emitted by the photodiode.

13. The monolithic junction thermometer of claim 12, wherein the silicon based mechanical element is configured to reflect the photons transmitted by the photonic crystal cavity.

14. The monolithic junction thermometer of claim 13, wherein the photodetector is configured to detect the photons reflected by the silicon based mechanical element.

15. The monolithic junction thermometer of claim 9, wherein the silicon based mechanical element includes silicon nitride.

16. The monolithic junction thermometer of claim 9, wherein the circuitry is configured to output a signal indicative of a junction temperature of the silicon based die.

17. The monolithic junction thermometer of claim 16, wherein the signal is a voltage signal.
